(19) United States
(12) Patent Application Publication
(10) Pub. No.: US 2016/0317904 A1
(43) Pub. Date: Nov. 3, 2016

(54) PROJECTION TYPE BILLIARD SYSTEM GESTURE/BILLIARD-ROD CONTROL SYSTEM AND IMPLEMENTATION METHOD THEREOF

(71) Applicants: Bing QIAO, Hebei (CN); Jiaoang LI, Liaoning (CN)

(72) Inventors: Bing QIAO, Hebei (CN); Jiaoang LI, Liaoning (CN)

(21) Appl. No.: 15/104,987

(22) PCT Filed: May 29, 2015
(86) PCT No.: PCT/CN2015/080155

§ 371 Date: Jun. 16, 2016

(30) Foreign Application Priority Data
Jul. 2, 2014 (CN) 201410312227.X

(51) Int. Cl. A63D 15/00; H04N 9/31; H04N 7/18; G03B 29/00

(52) U.S. Cl. CPC A63D 15/00; G03B 29/00; H04N 9/3194; H04N 7/18

(57) ABSTRACT

A projection type billiard system gesture/billiard-rod control system and an implement method thereof. The system comprises an image capture device (7), a projection device (6) and a computer (3). The signal output end of the image capture device (7) is connected to the input end of the computer (3). The input end of the projection device (6) is connected to the output end of the computer (3) and controlled by the computer (3). A hollow billiard lighting lamp (4) and an infrared light supplementary lamp (5) are further provided. The method includes that the computer (3) controls the projection device (6) to project an operation interface comprising various function buttons in a system program on a table surface of a billiard table (8). The computer (3) controls the image capture device (7) to capture images in the scope of the table surface of the billiard table (8) in real time. Background comparison analysis and previous-frame comparison analysis are carried out on current images, and a changed image area in the images is further obtained. The part, close to the billiard table (8), in the changed area is set to be the initial end of the changed area, and the other end is the tail end of the changed area. When the residence time of the tail end in a certain function button area scope of the operation interface is longer than a preset time, it is considered that the button is clicked and selected by a user, and the computer (3) operates the corresponding system function.

### BACKGROUND OF THE INVENTION

The invention herein generally relates to infrared application, projection control and computer-driven image recognition, applied in the sports training, assist and activities of billiards including 8-ball pool, 9-ball pool and Snooker for all kinds and levels of billiards lovers, and particularly to the gesture/cue control system and the method for the projection billiards system.

With the increasing maturity of infrared and projection technology, it's gradually combined with the billiard sports so that users will watch directly the projection of the billiard prejudgment track, special interaction effects and prompt information of hitting billiards, etc on the billiard table while playing billiards, which is really good news for billiards lovers. However, these systems need supporting from the mouse, keyboards or the remote control in its operation. You can imagine how inconvenient it is to the user that he must control the computer by a mouse or a keyboard with on hand when he holds the cue in the other hand to play billiards. Since some information has been projected on the billiard table by the projection device, why not make it easy to operate the running of the system directly by hand or cue on the billiard table?

### BRIEF SUMMARY OF THE INVENTION

In order to overcome the drawbacks of the prior art, an objective of the present invention is to provide a control system and method for the projection billiards system, which is controlled directly by the hand, cue or other similar objects.

In order to achieve the above objective, the present invention proposes the following solutions: a gesture/cue control system of the projection billiard system comprising the image acquisition device, the projection device and the computer, where the signal output end of the image acquisition device is connected to the input end of the computer, and the input end of projection device is connected to the output end of the computer and controlled by the computer, and hollow billiards lights and infrared light supplement lamps are also equipped;

The lens of the image acquisition device where a visible light filter is added, and of which the head end is aimed at the hollow part center of the hollow billiards light and no under the bottom of the hollow billiards light(4) configured for capturing the image in the desktop of the billiards table;

The infrared light supplement lamp fixed on the hollow billiards light, of which lighting end is as high as the bottom of the hollow billiards light configured for infrared lighting on the billiards table and filtering the visible light in the image acquisition device;

The system program in the computer(3) including that the control interface of all function buttons are projected on the desktop of the billiards table(8) through the projection device(6) to acquire real-time images captured by the image acquisition device(7) shone in the light of the infrared light supplement lamp(5), and compares and analyzes the current image with the background image or previous image through Open CV so as to get the changed area of the image and regard it as the moving gesture/cue area; that set the end near close to the edge of the billiards table in the changed area as the start of the change area and the other as the end, and it is regarded as that the button is selected by the user and the computer(3) runs the corresponding system function when the end stays in the function button area on the control interface over the preset time;

The hollow billiards light is at the top of the billiards table, so that the image acquisition device is right in front of the center of the billiards table.

The image acquisition device is fixed with the hanger of the image acquisition device.

The projection device and the computer are both installed at the bottom of the projection hanger and hung to the side of the hollow billiards light.

The hollow billiards light is hung at least 1 meter high above the billiards table.

A method for the gesture/cue control system of the projection billiards system comprising:

The computer controls the projection device to project the control interface including various function buttons of the system program on the desktop of the billiards table;

The computer controls the image acquisition device to collect real-time images within the desktop of the billiards table, compare and analyze the current image with the background or the previous frame image through Opencv so as to acquire the change area of the image and regard it as the moving gesture/cue area;

Set the part near close to the edge of the billiards table in the changed area as the start of the changed area and the other as the end, and it is regarded as that the button is selected by the user and the computer(3) runs the corresponding system function when the end stays in the function button area on the control interface over the preset time.

Judge the operation is by hands or cues through the end width of the change area.

The computer will analyze the gesture shape of the hand in the image and perform the corresponding operation according to the preset gesture shape after it's judged that the operation is by hand.

Also comprising: the computer collects the image area in a number of consecutive frame images, and if it's the consecutive actions in the change area, the computer will perform its corresponding system functions.

The image area set representing the change of unconventional actions and the system task set thereof are preset in the computer, and the corresponding system task will be performed when it's checked that the change area belongs to the set.

The computer controls the projection device to project a image at the size of a billiard at the end of the change area if the system function is that the user selects the object ball or a position; judge whether there's a billiards at the end of the change area by comparing and analyzing the current image with the background image or the previous frame image; if there's a billiards, judge whether the end of the change area is moving in the setting time, set the billiards as the target ball if it's not moving and return to the step that judge whether there's a ball at the end of the change area ; if there's no billiard, judge the end of the change area is moving in the setting time, set this position as an estimated position the billiards will move to if it's not, and return to the step that judge whether there's a billiard at the end of the change area.

Therefore, the following advantages and good effects of the present invention become apparent:

When playing billiards, the user controls the operation of the system directly by hand or cue, instead of another mouse, keyboard or other control, which is simple and easy.

The billiard table becomes a touch screen of the computer, which is not only in line with the user's operating habits, but also convenient and fast.

The problem that the user breaks the mouse or keyboard carelessly when he plays billiards along with it is solved, and at the same time the user can concentrate on playing without any other objects in his hand.

As the cue is just like the extension of the arm, the user can complete the function he wants just standing there and pointing with his cue, other than moving around, which will save time and improve the efficiency.

### BRIEF DESCRIPTION OF THE DRAWINGS

FIG. 1 is a structural diagram of the system provided in accordance with the present invention;

Thereinto, 1. projection hanger, 2. hanger of the image acquisition device, 3. Computer, 4. Hollow billiards light, 5. infrared light supplement lamp, 6. Projection device, 7. Image acquisition device, 8. Billiard table, 9. Billiards, 10. Cue.

### DETAILED DESCRIPTION OF THE INVENTION

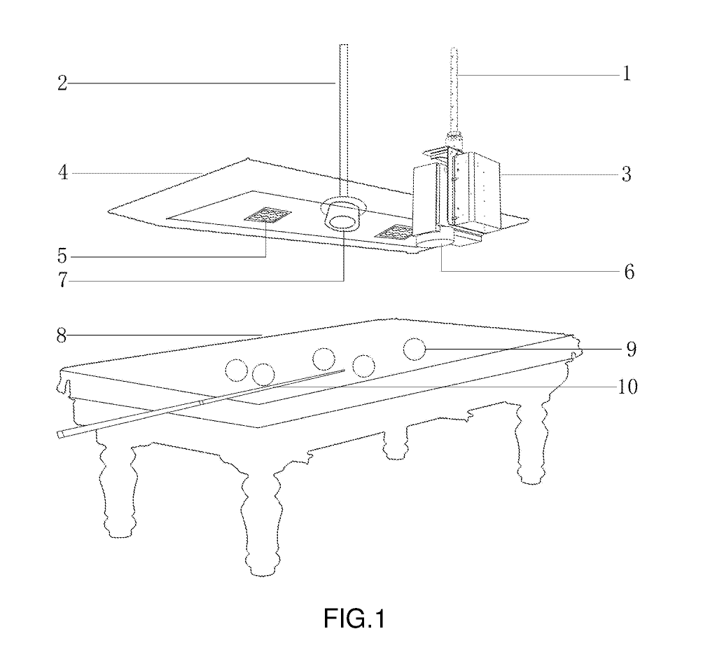

The present invention will now be described more specifically with reference to FIG. 1 and the following embodiments.

In one embodiment, the computer controls the projection device, projects the control interface of the system program on the billiards table, and stores the area coordinate of each function button on the control interface. When there's the gesture or cue action on the billiards table, the computer will collect real-time images within the desktop of the billiards table and use Opencv with C Language to compare and analyze the current image with the background and the previous frame image so as to acquire the change area in the image, that is, the area of the hand or cue operating, and then analyze and judge the change area. Comparing and analyzing the background is that: first take the billiards table without any billiards as the background image, then compare and analyze the image of the billiards table where a billiards is placed with the background image and acquire the billiards position. Comparing and analyzing the previous frame is that: compare the two neighboring frames of the projection collected, and determine the change area of the cue or hand by judging the change part.

In one embodiment, as the operator stands near the billiards table, the change area will be extended from the area around the table to its center. Then the part near close to the edge of the billiards table in the changed area is seen as the start of the change area and the other as the end. It is regarded as that the button is pressed by the user and the computer(3) runs the corresponding system function when the end stays in the function button area on the control interface over N seconds( This residence value can be set by the system).

In one embodiment, the shape of the end in the change area can be judged by the computer. The distinction between a hand and a cue is made by the width of the change area. If it is a hand, its gesture shape will be analyzed and the corresponding function will be performed according to the special preset gesture shape. For example, making a first and pointing to the left with the thumb only and putting it above the billiards table means paging to the left, and conversely it means paging to the right, etc.

In one embodiment, the change area in a plurality of consecutive frame images can be analyzed by the computer. Displacement of the hand or cue is judged for controlling the system to perform the slider or paging operation of the function buttons according to the end position, residence area and the coordinate change of the hand or cue. Whether the end moves back and forth in a certain time and area can also be judged, which is regarded as that the user intentionally shakes his hand or cue to control the system, and the system will perform such corresponding system function as popping up the menu or returning back according to the judgment of the action.

In one embodiment, the computer can analyze whether there's some unconventionally special action in the change area. For example, the action that the start and the end of the change area are close to the two middle pocket of the billiards table will be regarded as that the cue is fat and stretched across the billiards table. As it is unconventionally special, this action can be preset and regarded as the action of popping up the corresponding function menu in the process of playing, so that the computer can control the projection device to pop up the corresponding function menu and project it on the billiards table for the user.

In one embodiment, as the billiards table is relatively large, the operator need move around because of the different position of the interface if it's operated only with hands, which is not very convenient. The cue hereof is just like the extension of the user's hand, which can operate the system to select the object ball and the estimate position of the billiards, etc taking the place of hands.

In one embodiment, the billiards environmental model is established in the computer, used for simulating the movement track after hit of the cue ball, the track of the object ball hit directly/indirectly by the cue ball and the rebound track of the object ball; capturing the image of billiards on the billiards table and getting the billiards coordinate when the billiards is still; capturing the real-time coordinate of the two cue ends and hitting directions when the user bends to aim the cue ball with the cue, and regarding the first ball pointed by the tip of the cue as the cue ball.

In one embodiment, if the cue is moved on the billiards table and at this time the system function is that the user selects the object ball or a position, the computer will project a image at the size of a billiard as an identification for the user's reference at the position pointed by the end after the end of the cue is analyzed. And then analyze whether there's billiards at the end of the cue, if there's billiards and the cue isn't moved in a certain time, it's regarded as that select this position as the estimate position where some billiards will run at the next step calculated by the system. If the cue is moved in a certain time, it's regarded as that the user will select other ball or position as the object, and then repeat the above operation. Take the position without a ball on the billiards table designated by the user as the end point of the track the cue ball will run, and figure out the hitting strength, hitting point, the cue angel and the running track with which the cue ball reaches the designated ending, according to the coordinate of the cue, that of the object ball and of the cue ball as well as the end-point ordinate of the track where the cue ball will run; Take the certain billiards designated by the user on the billiards table as the next object ball to hit, and figure out the position where the cue ball runs and hits the next object ball and its running track according to the coordinate of the cue, that of the object ball and of the cue ball as well as the coordinate of the next object ball to hit. Project the track with which the billiards will run to the billiards table with the projection device.

1. A gesture/cue control system for projection billiards system, comprising: The computer (3), image acquisition device (7) of which the signal output end is connected to the input end of the computer (3), and projection device (6) of which the input end is connected to the output end of the computer (3) and controlled by the computer (3), wherein hollow billiards light (4) and infrared light supplement lamp (5) are also equipped; The lens of the image acquisition device (7) where a visible light filter is added, and of which the head end is aimed at the hollow part center of the hollow billiards light (4) and no under the bottom of the hollow billiards light (4) configured for capturing the image in the desktop of the billiards table (8); The infrared light supplement lamp (5) fixed on the hollow billiards light (4), of which lighting end is as high as the bottom of the hollow billiards light (4) configured for infrared lighting on the billiards table (8) and filtering the visible light in the image acquisition device (7); The system program in the computer (3) including that the control interface of all function buttons are projected on the desktop of the billiards table (8) through the projection device (6) to acquire real-time images captured by the image acquisition device (7) shone in the light of the infrared light supplement lamp (5), and compares and analyzes the current image with the background image or previous image through Open CV so as to get the changed area of the image and regard it as the moving gesture/cue area; that set the end near close to the edge of the billiards table in the changed area as the start of the change area and the other as the end, and it is regarded as that the button is selected by the user and the computer (3) runs the corresponding system function when the end stays in the function button area on the control interface over the preset time; The hollow billiards light (4) is at the top of the billiards table (8), so that the image acquisition device (7) is right in front of the center of the billiards table (8).

2. The system of claim 1, wherein the image acquisition device (7) is fixed by the hanger of the image acquisition device (2).

3. The system of claim 1, wherein the projection device (6) and the computer (3) are both installed at the bottom of the projection hanger (1) and hung to the side of the hollow billiards light (4).

4. The system of claim 1, wherein the hollow billiards light (4) is hung at least 1 meter high above the billiards table (8).

5. A method for the gesture/cue control system of the projection billiards system according to claim 1, comprising: the computer (3) controls the projection device(6) to project the control interface including various function buttons of the system program on the desktop of the billiards table (8); the computer (3) controls the image acquisition device (2) to collect real-time images within the desktop of the billiards table (3), compare and analyze the current image with the background or the previous frame image through Opencv so as to acquire the change area of the image and regard it as the moving gesture/cue area; set the end near close to the edge of the billiards table in the changed area as the start of the changed area and the other as the end, and it is regarded as that the button is selected by the user and the computer (3) runs the corresponding system function when the end stays in the function button area on the control interface over the preset time.

6. The method of claim 5, wherein it's through the end width of the change area that judge the operation is by hands or cues.

7. The method of claim 6, wherein the computer (3) will analyze the gesture shape of the hand in the image and perform the corresponding operation according to the preset gesture shape after it's judged that the operation is by hand.

8. The method of claim 5, also comprising that the computer (3) collects the image area in a number of consecutive frame images, and if it's the consecutive actions in the change area, the computer (3) will perform its corresponding system functions.

9. The method of claim 5, wherein the image area set representing the change of unconventional actions and the system task set thereof are preset in the computer (3), and the corresponding system task will be performed when it's checked that the change area belongs to the set.

10. The method of claim 6, wherein the computer (3) controls the projection device (6) to project a image at the size of a billiard at the end of the change area if the system function is that the user selects the target billiards or a position; judge whether there's a billiards at the end of the change area by comparing and analyzing the current image with the background image or the previous frame image; if there's a billiards, judge whether the end of the change area is moving in the setting time, set the billiards as the target ball if it's not moving and return to the step that judge whether there's a ball at the end of the change area ; if there's no billiard, judge the end of the change area is moving in the setting time, set this position as an estimated position the billiards will move to if it's not, and return to the step that judge whether there's a ball at the end of the change area.

11. The method of Ciaim 7, wherein the computer (3) controls the projection device (6) to project a image at the size of a billiard at the end of the change area if the system function is that the user selects the target billiards or a position; judge whether there's a billiards at the end of the change area by comparing and analyzing the current image with the background image or the previous frame image; if there's a billiards, judge whether the end of the change area is moving in the setting time, set the billiards as the target ball if it's not moving and return to the step that judge whether there's a ball at the end of the change area; if there's no billiard, judge the end of the change area is moving in the setting time, set this position as an estimated position the billiards will move to if it's not, and return to the step that judge whether there's a ball at the end of the change area.
